(19) United States
(12) Patent Application Publication
(10) Pub. No.: US 2019/0207896 A1
(43) Pub. Date: Jul. 4, 2019

(54) Mechanism for Improving Interpersonal Information Transfer Over Time

(71) Applicant: Dan Stewart, Safety Harbor, FL (US)

(72) Inventor: Dan Stewart, Safety Harbor, FL (US)

(21) Appl. No.: 16/216,373

(22) Filed: Dec. 11, 2018

Related U.S. Application Data
(60) Provisional application No. 62/612,496, filed on Dec. 31, 2017.

(51) Int. Cl. H04L 12/58; G06Q 30/02

(52) U.S. Cl. CPC H04L 51/22; H04L 51/34; H04L 51/36; G06Q 30/0277; H04L 51/32; H04L 51/10; G06Q 30/0243

(57) ABSTRACT

A web-based mechanism for improving interpersonal information transfer over time is disclosed. Specifically, an Internet-based method whereby a member creates a series of web-based stimuli to be consumed by a respondent. The respondent's responses and the time, or other conditions associated with the respondent's response, are used to create a communication plan.

### CROSS-REFERENCE TO RELATED APPLICATIONS

This application relies on U.S. Prov. Pat. App. No. 62/612,496 filed Dec. 31, 2017 which it incorporates, in its entirety, by reference.

### FIELD OF THE INVENTION

The present invention relates to a web-based mechanism for improving interpersonal information transfer over time. Specifically, the invention is an Internet-based method whereby a member creates a series of web-based stimuli to be consumed by a respondent. The respondent's responses and the time the respondent takes to respond are used to create a communication plan.

### BACKGROUND OF THE INVENTION

Email and text messaging are well known communications methods. But the amount of time used to respond to these messages is not tracked or even monitored. More importantly, the nature of the interaction is very standardized. The only interaction allowable is to respond.

But stimuli can be something other than a discreet message. A stimulus can be a question. A stimulus can be a video clip or some other multimedia presentation. A stimulus can be a link to a web page. Moreover, other aspects dealing with the nature of responding to the stimulus may be tracked. These other aspects include whether a stimulus is responded to, the time required to respond to the stimulus, and what the nature of the response was (text, web site navigation, response to a question, etc.).

What is needed therefore is a web-based mechanism for improving interpersonal information transfer over time whereby a member easily creates various stimuli, presents them to respondents, and the time and type of response is tracked. By tracking this data, a communication strategy may be created and improved.

### SUMMARY OF THE INVENTION

The present invention relates to a web-based mechanism for improving interpersonal information transfer over time.

The present invention is an Internet-based method whereby a member creates a series of web-based stimuli to be consumed by a respondent. The web-based stimuli comprise questions which are answered by a respondent. The respondent is shown the member's provided answer to the question. The member is shown the respondent's answer.

The respondent's answer, the time required to answer, whether the respondent interacts with other member provided web-based stimuli, whether the respondent interacts with email sent by the member in response to the stimuli, and whether the respondent creates their own web-page resulting from their observations of the member's provided stimuli are used to create a communication plan.

DESCRIPTION OF DRAWINGS

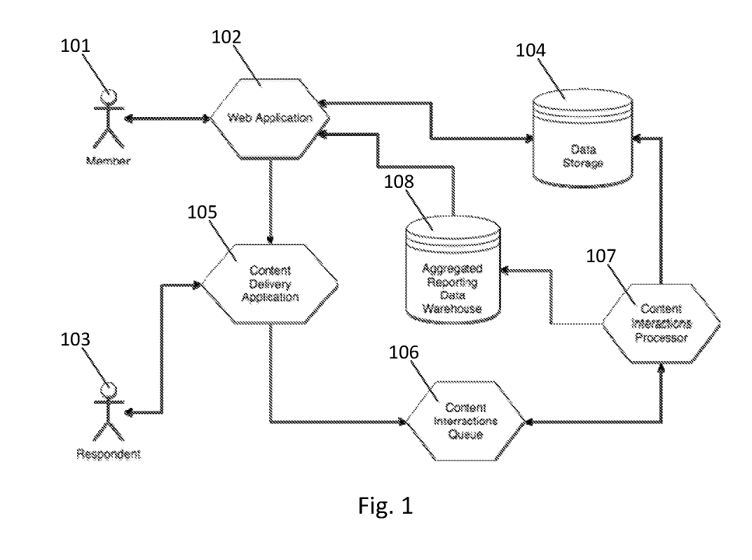

FIG. 1 is a flowchart showing how the system is constructed and used.

### DETAILED DESCRIPTION OF THE PREFERRED EMBODIMENT

The present invention relates to a web-based mechanism for improving interpersonal information transfer over time.

The invention comprises a system that contains the following steps:

A member constructs a landing page or pages that are populated with content selected by the first party (the member) and shared with the second party (the respondent). A variety of means may be used for sharing, including link sharing via email, text messaging, social media, and advertising.

The content appearing on the member page may include pictures, videos, logos, and a series of questions either selected or created by the member.

The member pages are constructed in such a way that they are easily configurable by the member and instantly available for sharing upon completion.

The graphic content of the member page is selected from a library of templates. The video, logos, and/or photos on the page are provided by the member or generated from the member's social media accounts. The textual content is provided by the member. This includes a series of questions.

After the member constructs the page(s), the member approves the page(s) and invites respondents to view them via email, text messing, social media, advertising, and/or other means of sharing the page(s).

Page visitors (respondents) are invited to answer the series of questions selected by the member. For each question they answer, they are shown the member's answer to the same question.

The respondent's answers to the members questions are saved and shared with the members.

Based on the respondent's actions and the time the respondent took to respond, a communication plan is created and suggested to the member based on the following criteria: a) The respondent's answers to the member's questions; b) The time interval between being invited to answer and providing an answer; c) The engagement with subsequent requests to visit additional landing pages; d) The engagement with email sent from the member to the respondent; and, e) The respondent's decision to create and deploy their own member pages.

Specifically, as to the time interval between the respondent's answers to the member's questions, the intervals generated by respondents when they complete questions are measured such that their association with the most highly engaged prospects can be determined and reported. For example, if a time period is reported as being associated with the most motivated prospects, response times near the time period reported as being associated with the most motivated prospects are ranked more highly. Response times away from the time period reported as being associated with the most motivated prospects are ranked lower.

Referring now to FIG. 1, member 101 uses web application 102 to construct content that will be delivered to respondent 103. The addresses of respondent 103 who receives content is provided to web application 102 sometime before content is sent to respondent 103. The address of respondent 103 is stored in data storage 104 and retrieved when needed.

Content created by member 101 in web application 102 can be emails, text messages, multimedia messages and the like. When member 101 is ready to send content, respondent's 103 address is retrieved from data store 104. Next, member's 101 content and respondent's 103 address are passed to content delivery application 105. The role of content delivery application 105 is to deliver member 101 created content to respondent 103 and to capture respondent's 103 interaction with the content. Respondent's 103 interactions are sent to content interactions queue 106 where they are stored/queued until they can be processed by the content interactions processor 107.

Content interactions processor 107 is responsible for processing each content interaction. Content interactions can be categorized under delivery events and event times (the time at which a message was sent, the time at which a message was processed, the time at which a message was dropped, the time at which a message was delivered, the time for which the delivery of a message was deferred, and the time it took before a message was bounced) and engagement events and event times (the time required to open a message, the time to click on a message in the messaging program, the amount of time required to report a message as spam, and/or the time to unsubscribe from a message source). Content interactions processor 107 aggregates interactions and stores the aggregated values in aggregated reporting data warehouse 108, it also stores some non-aggregated data in data storage 104 for later retrieval by web application 102.

Web application 102 uses the aggregated values to report on the efficacy of a message stream. For example, for a particular respondent, if message A has a time required to open the message of 5 minutes and message B has a time required to open the message of 50 minutes, the it is can be recorded for that for that particular respondent that message A was likely more effective in delivering content to the respondent than was message B. This derived conclusion is stored in data warehouse 108.

1) A web-based mechanism for improving interpersonal information transfer over time comprising:
a) a message written by a member and presented on a member's web-page;
b) a response generated by a respondent after being invited to view a member's message;
c) wherein the amount of time required to generate a response is compared to the optimal time required to generate a response and this comparison is reported to the member.

2) A web-based mechanism for improving interpersonal information transfer over time of claim 1 wherein the electronic communication method is email.

3) A web-based mechanism for improving interpersonal information transfer over time of claim 1 wherein the electronic communication method is text messaging.

4) A web-based mechanism for improving interpersonal information transfer over time of claim 1 wherein the electronic communication method is a web-page.

5) A web-based mechanism for improving interpersonal information transfer over time of claim 1 where efficacy is measured in terms of the time a message was sent.

6) A web-based mechanism for improving interpersonal information transfer over time of claim 1 where efficacy is measured in terms of the time a message was processed.

7) A web-based mechanism for improving interpersonal information transfer over time of claim 1 where efficacy is measured in terms of the time at which a message was dropped.

8) A web-based mechanism for improving interpersonal information transfer over time of claim 1 where efficacy is measured in terms of the time at which a message was delivered.

9) A web-based mechanism for improving interpersonal information transfer over time of claim 1 where efficacy is measured in terms of the amount of time that a message was deferred.

10) A web-based mechanism for improving interpersonal information transfer over time of claim 1 where efficacy is measured in terms of the time at which a message was bounced.

11) A web-based mechanism for improving interpersonal information transfer over time of claim 1 where efficacy is measured in terms of the time at which a message was opened.

12) A web-based mechanism for improving interpersonal information transfer over time of claim 1 where efficacy is measured in terms of the time at which a message was clicked.

13) A web-based mechanism for improving interpersonal information transfer over time of claim 1 where efficacy is measured in terms of the time at which a message was reported as spam.

14) A web-based mechanism for improving interpersonal information transfer over time of claim 1 where efficacy is measured in terms of the group or service which sent the message was unsubscribed from.
